(19) United States
(12) Patent Application Publication
(10) Pub. No.: US 2023/0363361 A1
(43) Pub. Date: Nov. 16, 2023

(54) SYSTEM, METHOD AND APPARATUS FOR MOBILE FISH CULL TRACKING AND MANAGEMENT AND SMART DEVICE INTERFACE

(71) Applicant: Cullmaster Technologies LLC, Louisville, KY (US)

(72) Inventor: Timothy D. Clark, Louisville, KY (US)

(73) Assignee: Cullmaster Technologies LLC, Louisville, KY (US)

(21) Appl. No.: 18/187,663

(22) Filed: Mar. 22, 2023

Related U.S. Application Data
(60) Provisional application No. 63/364,561, filed on May 11, 2022.

(51) Int. Cl. A01K 61/95; A01K 97/00; G01G 19/60; G01G 23/44

(52) U.S. Cl. CPC A01K 61/95; A01K 97/00; G01G 19/60; G01G 23/44

(57) ABSTRACT

A Fishing Competition Management and Administration (FCMA) system includes communications and cull management capabilities. The FCMA system includes an angler-based system and an event organizer-based system. The angler-based system is based on a weigh scale and set of cull floats or markers for attachment to each caught and retained fish. The culling product includes the weigh scale and a set of six culling devices, each culling device has a different color. As a fish is caught and weighed, the Culling or Weight Scale will signal to a colored culling float in or outside of the live well. The culling scale determines and stores the weight associated with that particular-colored float and will properly record the weight next to the proper weight color on the screen.

### FIELD OF INVENTION

The present invention generally relates to fish culling and weighing particularly in connection with fishing events, tournaments or leagues.

### BACKGROUND OF THE INVENTION

Fishing has long been a popular sport and has attracted a large number of fishing enthusiasts. Fishing tournaments and leagues are becoming increasingly popular events and are held throughout the United States and beyond. With increasing popularity, the competitive nature of the events has also increased and fishing in such events is taken very seriously. In addition to trophies and other awards, those winning or finishing at the top of the field in these tournaments receive significant monetary prizes and awards. Sponsors provide additional forms of compensation for the elite of the sport.

In connection with fishing tournaments, teams of anglers are sent out on a given lake or river or location with the goal of catching the “biggest fish” so to speak. Competitions may be limited to particular fish species and may be limited further to minimum size, weight, length, number of fish allowed to be weighed, and other parameters or attributes. As fish are caught, qualifying fish are collected, such as in a live well, and tagged to keep track of the data associated with the fish. Typically, colored culls, bobs or floats are attached to the fish to help organize and keep track of the caught fish. Once an angler has collected and met the limit on the number of fish allowed in the tournament then the angler must cull fish as additional fish are caught and replace outsized or lesser prized fish in the live well. Specifically, the act of culling is when an angler or team of anglers or fishers has reached their limit of fish and have to either replace the newly caught fish with one of the fish from the live well or release it. Most fishing tournaments do not permit contestants to keep more fish in their live well once they have their tournament limit. Accordingly, this process of culling fish is critical and competitors desire to have accurate and dependable ways to track the fish that are caught and stored in the live well.

A couple of scenarios illustrate the conditions and difficulties anglers face during a competition. Case Scenario: A bass tournament has a five fish limit, which means the participants are required to weigh in the fisherman's heaviest five fish. A cull occurs when the angler has caught five fish and has placed them in the live well. Then a 6th fish is caught, which is heavier than one of the five already in the live well, the angler would replace the “then-current” lightest fish, with the newest fish, and place the lightest fish back in the water, therefore maximizing their total weight. This process continues for the entire tournament. This process is a very manual, cumbersome, inaccurate, and time-consuming process today. What is needed is a culling system to increase the speed, accuracy, decision making, and global communication of a fishing tournament cull.

One exemplary prior art Weighing scale system is disclosed in U.S. Pat. Publ. 2013/0168161 (Saulters et al.). Examples of prior art systems available today are: T-H Marine G-Force culling system, H2O XPRESS Culling System available at Academy Sports, Berkley Tournament Culling Kit available at discounttackle.com, and Gator Grip Culling System available at sportsmans.com. None of these prior art culling systems provided any degree of connectivity and real-time reporting and communicating of performance at any level.

Although not widely used in connection with fish culling systems, mobile applications or “apps” are widely used with smart phones and other smart devices for a wide variety of uses. Also, smart devices such as smart phones are increasingly provided with multiple communication protocol capabilities for receiving and transmitting data based on known protocols, e.g., UWB, Bluetooth, BLE, and WiFi. By connecting a smart phone with a device having matching communications capabilities, the smart phone may be used to capture data collected by the connected device and packetize or otherwise package or prepare such data for internal processing and/or transmission of the collected and processed data to other devices such as a central server or processing device.

There exists today a number of known communications protocols or platforms, e.g., UWB (Ultra-Wideband), RFID (Radio-Frequency Identification), Bluetooth (BR/EDR protocol), BLE (Bluetooth Low Energy—Bluetooth Smart), NFC (Near Field Communication), and WiFi (Wireless Fidelity), that provide highly effective communications between appropriately and compatibly equipped devices. Professional and standards setting bodies, including IEEE (Institute of Electrical and Electronics Engineers) and Bluetooth Special Interest Group (SIG), as well as universally available resources, including Wikipedia, provide open access to technical specifications and implementation information for each of these known platforms.

Many of these platforms are employed using IC (Integrated Chip) or microchip and antenna components and may involve use of SDR (Software-Defined Radio) and/or other embedded techniques. Each of the above-referenced protocols and platforms has advantages and disadvantages when compared with one another. For example, WiFi and Bluetooth offer greater range when compared with UWB. However, and while WiFi and Bluetooth/BLE have been adapted to provide location services, UWB has clear advantages over RFID, Bluetooth/BLE and WiFi in connection with applications requiring highly precise real-time location discovery and ranging services in a short-range use environment to scan, detect and determine spatial location and movements of detected or responding objects. An array of detectable objects may be deployed in support of such services and once connected, data may be communicated between devices using one or more or a combination of these protocols.

One important feature of such systems is the desire to provide secure transmissions and communications to avoid interception by unauthorized devices in proximity to the communications exchange. The platforms may use AES (Advanced Encryption Standard) encryption/decryption and application layer security. Applications may also employ known Public Key Infrastructure (PKI) and Public-Key Encryption (PKE) cryptography, or asymmetric cryptography. PKI is a platform that effectively binds public keys with identities through use of registration and issuance of digital certificates, such as issued by a known Certificate Authority (CA). PKI involves established policies and procedures required to create, manage, distribute, use, store and revoke digital certificates and manage PKE. PKE is a cryptographic system using pairs of keys, where each key-pair consists of a public key (which may be known to others) and a private key (which may not be known by anyone except the owner). ITU (International Telecommunication Union) established the X.400 and X.500 protocols related to electronic delivery services and including the X.509 cryptography standard on which public key certificates are based. The generation of such key pairs depends on cryptographic algorithms which are based on mathematical problems termed one-way functions. Effective security requires keeping the private key private; the public key can be openly distributed without compromising security.

In connection with development of such technologies, the IEEE standards setting organization has formed a number of working groups aimed at developing standards for each service. For example, IEEE 802.15 is a working group to specify WPAN-related standards for use in unified commercial deployment. BLE (Bluetooth 4.0-4.2, Bluetooth Smart) is a WPAN (Wireless Personal Area Network)-based solution that may be used in connection with data collection, packetization and exchange and is versatile in working with a range of smartphone applications. For example, BLE provides a platform established as a low energy solution to promote transmitters and/or transceivers to “broadcast” an identifier for detection by and communications with nearby devises such as smartphones having interoperable operating systems or APIs or applications running thereon. Many common mobile operating systems including iOS, Android 4.3 and later, Windows Phone and BlackBerry, as well as macOS, Linux, Windows 8 and later, natively support BLE.

Packetization of data utilized in BLE-based systems include a BLE protocol stack or links and is made up of functional main layers relating to the controller, the host, and application profiles and services. The controller portion is comprised of several layers including BLE PHY (PHYsical layer) and LL (Link Layer or data link layer), and the controller-side host controller interface (HCl). The Host portion is comprised of several layers including, L2CAP (Logical Link Control & Adaptation Protocol—adaptation protocol layer), GAP (Generic Access Profile—specifies roles, modes, and procedures of a device), GATT (Generic Attribute Protocol—encapsulates the ATT and is responsible for coordinating the exchange of profiles in a Bluetooth LE link), ATT (Attribute Protocol—transfers attribute data between clients and servers), and SMP (Security Manager Protocol—applies security algorithms to encrypt and decrypt data packets). The App (Application Layer) layer is the direct user interface defining profiles that afford interoperability between various applications. The Bluetooth core specification enables vendors to define proprietary profiles for use cases not defined by SIG profiles. The BLE connection or handshake establishment procedure involves three phases—discovery phase, connecting phase and connected phase. A connection involves two devices, one a master and one a slave with GAP and GATT serving respective central, client and peripheral roles in the process. Interfaces are integrated on microcontrollers and cover the data link layer, with the physical layer implemented externally. A common asynchronous interface used in BLE applications is a BLE UART interface that simulates a UART (Universal Asynchronous Receiver Transmitter) or USART (Universal Synchronous/Asynchronous Receiver Transmitter) or Serial Communication Interface (SCI) at the Link Layer or data link layer.

Using the appropriate stack protocol and designated layer, data is packetized with payload, identification, and other information and packaged as a signal for communication and delivery to a receiving or destination device at both the source host and destination host. Bluetooth 5.0-5.1 is the successor specification to Bluetooth 4.2, has greater range and message capacity and faster communication speed, and is used in IoT and Beacon applications and all devices communicate over BLE.

UWB is an IEEE 802.15.4a/z standard-based platform for secure, highly accurate real-time short-range location-based applications. UWB is a radio-based communication technology for short range applications and are typically integrated and embodied in microchip and antenna form. UWB measures distance and location with great accuracy—typically within a few centimeters. UWB calculates the time taken for radio signals to travel between devices to provide an essentially real-time and highly stable communication platform. UWB can be used to capture highly accurate spatial and directional data to support space or location-sensitive uses where precise location of a device/person is important to performance of desired functions. The UWB Forum was an industry organization formed to promote interoperable UWB wireless computer networking products and led to the formation of the UWB Alliance including numerous automotive companies.

Additional research and development are underway by several industry groups. For example, the FiRa (Fine Ranging) Consortium led by Samsung, Xiaomi, NXP, Sony, Bosch and others, is working to expand the UWB technology and ecosystem based on the existing IEEE 802.15.4/4x standard for low-data-rate wireless communication. FiRa leverages the IEEE 802.15.4 standard, which defines the characteristics of the UWB wireless interface to develop standards for the protocol stack, security keys, and other requirements to develop a secure interface for specific application segments.

UWB is used in many applications including IoT (Internet of Things) applications and in connection with smart devices such as smart phones. For example, vehicle-based equipment may come equipped with UWB transceivers to communicate or otherwise respond to the presence of UWB equipped devices. More and more smartphones include UWB-enhanced capabilities for providing secure services transmitting data and spatial and directional awareness on personal devices, e.g., AirDrop on iOS 13.1 on the iPhone 11 having the U1 chip, and similar features on Android-based personal smart devices such as made by Samsung, Huawei and others.

### SUMMARY OF THE INVENTION

The invention provides a Fishing Competition Management and Administration (FCMA) system that includes communications and cull management capabilities not previously known or available. The FCMA system includes an angler-based system and an event organizer-based system. The angler-based system is based on a weigh scale and set of cull floats or markers for attachment to each caught and retained fish. The culling product in one embodiment includes the weigh scale and a set of six culling devices (or culling floats), each culling device has a different color or is assigned a different color or other form of demarcation or differentiation from among the set of cull devices. For instance, a fish is caught and weighed. The Culling or Weight Scale will signal to a colored culling float in or outside of the live well by flashing the LED's built into the culling float. This is the culling float to be clipped or attached onto the fish. The culling scale determines and stores the weight associated with that particular-colored float and will properly record the weight next to the proper weight color on the screen. A “total weight” will also be recorded and stored in the application system each time that 1) an additional fish is weighed, or 2) a fish is culled, and the total weight is recalculated with the weight of the new fish. Additionally, each time a fish is culled, the culling float inside the live well will have its LED light flashing to direct the angler to which fish to immediately cull. Every fish caught with its weight will be stored in a database for analytics, to include date, time, weight, GPS location (if possible), tournament name. Additionally, there would be an IOS and Android mobile app to view all this data, which could be broadcast either directly or indirectly to a tournament director, fellow competitors via an accessible leader board, a network of friends, or viewed later by the angler to review their culling history. In addition, one or more cull devices or a separate device may be included to sense, measure and display the water temperature in the live well, the PH level of the live well, and/or other conditions relevant to the tournament.

The present invention provides a system and method for deploying Wi-Fi, cellular LTE, NFC, Bluetooth, BLE and/or UWB-enabled devices to enhance real-time collecting, communicating and sharing of information. More and more smartphones include UWB-enhanced capabilities for providing secure services transmitting data and spatial and directional awareness on personal devices, e.g., AirDrop on iOS 13.1 on the iPhone 11 having the U1 chip, and similar features on Android-based personal smart devices such as made by Samsung, Huawei and others. By working in connection with a smart phone UWB/BLE module, the present invention utilizes integrated Wi-Fi, UWB and/or BLE equipped beacon or antenna to provide secure access and collection of data associated with fishing tournaments as well as qualifying information and historical tracking of information.

In one embodiment, the present invention provides a weighing scale capable of communicating through IoT technology to a plurality of receiving devices. The weighing scale communicates with a set of one or more “cull devices” having an LED or other indicator to represent a defined cull activity. Each cull device from the set of cull devices has a different color (optionally an LED) to help distinguish it from the others. The weighing scale includes a load cell or weight sensor that acts as an analog-to-digital converter and records the weight of each fish caught in a memory and communicates through Internet or other wireless connectivity to a smart phone and to a central (FCMA) database system. The weighing scale includes Wi-Fi, BLE or other communications means to communicate with other compatible electronic devices, fish finders, mobile devices, or other integrated technologies. The weighing scale weighs, stores, and identifies which cull device contains the certain weight of a fish and will alert the fishing angler which fish in a live well needs to be culled and returned to the water.

The weighing scale may be further characterized in one or more of the following ways. It may include a touchscreen and one or more LEDs which illuminates various data elements to the angler. A remote database system records culling activity from each user, either independently, in a group (tournament) or other desired formats and reports various key information to any interested parties and access may be limited to those having access or an account established with the service or tournament organizer. Parties would include (competing anglers, tournament director(s), fish and wildlife, family, friends, or the anglers themselves. The weighing scale records GPS information of each catch and records to the remote database system for further analytics and data services to offer to users or other 3rd parties. A mobile application downloaded and running on a smart phone integrates with the culling system, central server and remote database. A Web application integrates with the culling system, a central server and a remote database. The weighing scale is waterproof and is battery operated with a rechargeable function. The cull mechanisms are waterproof and are rechargeable battery operated. The “CullMaster” system captures culling data for various uses and provides “Leaderboard” functionality application available for users, competitors, family, friends, or other interested third parties. One or more cull devices (Primary cull) may include a water (live well) temperature sensor and communicates live well temperature to a connected smart device and other devices. The Primary cull or other cull may include a ph meter to determine alkalinity of live well water oxygen content of the water and fish health.

In a first embodiment the present invention provides a fish weighing and data collection system comprising: a transportable fish weighing device adapted to be field deployable for remote use on watercraft, the fish weighing device comprising: a weighing component configured to measure the weight of a fish; a processor configured to execute instructions; a memory configured to store data and instructions executable by the processor; and a first communication component configured to wirelessly communicate with a cull device set and to wirelessly communicate with a mobile device; the cull device set comprising one or more cull devices, each cull device from the cull device set comprising: an attachment component configured to attach the cull device onto a fish in a fixed but removable manner for intended detachment from the fish; an indicator adapted to distinguish the cull device from an other cull device from the cull device set; and a second communication component configured to wirelessly communicate with the fish weighing device; wherein the fish weighing device measures and stores in the memory the weight of each fish attached to respective cull devices from the cull device set; and wherein the first communication component is adapted to establish a wireless connection with a mobile device and generate a signal to transmit weight information representing the measured weight of each fish attached to respective cull devices stored in the memory.

The first embodiment of the fish weighing and data collection system may be further characterized in one or more of the following manners: wherein the first and second communications components are configured to communicate using IoT technology; wherein the fish weighing device comprises a load cell or weight sensor configured as an analog-to-digital converter, and wherein the fish weighing device measures and stores in the memory the weight of each fish caught and communicates stored information through one or more of Internet, Wi-Fi, Bluetooth, BLE, IoT, NFC, RF or other wireless connectivity to one or more communicatively connected devices; wherein the communicatively connected devices include one or more of computer, smart phone, connectable wearable device, fish finder, mobile computing device, or other integrated technologies; wherein the fish weighing device processor is configured to execute instructions stored in the memory and compare, based on the stored fish weight information, relative weights of fish associated with respective cull devices and to generate a signal representing an identification of a fish in a live well to be culled in place of a newly weighed fish; further comprising a visual display adapted to present to a user information related to the system; wherein the first communication component is adapted to transmit collected and stored fish weight information to a database; wherein information is communicated to a mobile device operating an application adapted to receive data from the fish weighing device and is communicated to the database via the mobile device; wherein the database collects information and generates records associated with a plurality of users, and wherein the collected information includes culling activity from each user; wherein the database is configured to publish collected information via a remotely accessible hosted service, and wherein access to the hosted service is account-based; wherein the database is operated on a computer configured to provide a “Leaderboard” functionality application available to interested parties; wherein the fish weighing device records GPS information associated with a location of each fish caught and associated with a cull device; further comprising a mobile application configured to be operated via the mobile device, to receive data from the fish weighing device, and to communicate with a remote database; wherein the fish weighing device and the cull device set are configured to be waterproof and comprise a rechargeable battery; further comprising a water temperature sensor adapted to be disposed in a live well with one or more fish each having an associated cull device attached thereto and emit a signal representing a sensed water temperature, and wherein the fish weighing device or the mobile device is adapted to receive the signal from the water temperature sensor; further comprising a ph sensor adapted to be disposed in a live well containing fish with attached cull devices, wherein the fish weighing device is adapted to receive a signal from the ph sensor and to determine an alkalinity level of the live well water.

A second embodiment of the present invention provides a method for collecting and storing fish weight data, the method comprising: measuring, by a transportable fish weighing device, the weight of a fish, and generating a signal representing measured fish weight data; storing, by a memory in the transportable fish weighing device, the measured fish weight data; wirelessly communicating, via a first communication component of the transportable fish weighing device, with a cull device set; attaching the cull device onto a fish in a fixed but removable manner for intended detachment from the fish; wirelessly transmitting a signal, via a second communication component of the cull device, to the fish weighing device, the signal comprising a set of data representing measured fish weight data; and wirelessly connecting with a mobile device and generating a signal to transmit weight information comprising the weight of each fish attached to respective cull devices stored in the memory.

The second embodiment of the present invention may be further characterized in one or more of the following manners: further comprising: comparing, by a processor configured to execute instructions stored in the memory of the fish weighing device, based on the stored fish weight information, relative weights of fish associated with respective cull devices; and generating a signal representing an identification of a fish in a live well to be culled in place of a newly weighed fish; further comprising: capturing and storing GPS information associated with a location of each fish caught and associated with a cull device; further comprising transmitting a signal representing measured fish data from the fish weighing device to a mobile device via an application running on the mobile device.

### BRIEF DESCRIPTION OF THE DRAWINGS

In order to facilitate a full understanding of the present invention, reference is now made to the accompanying drawings, in which like elements are referenced with like numerals. These drawings should not be construed as limiting the present invention but are intended to be exemplary and for reference.

FIG. 1 provides a schematic view of one embodiment of a cloud-based wireless communications-enabled fishing tournament management and administration system in connection with the present invention.

FIG. 2 provides a schematic diagram of an exemplary competitor or participant fish culling and weighing and reporting system in accordance with the present invention.

FIG. 3 provides a more detailed functional block diagram of the exemplary competitor or participant fish culling and weighing and reporting system of FIG. 2.

FIG. 4 provides a detailed functional block diagram of an exemplary cull device associated with the competitor or participant fish culling and weighing and reporting system of FIGS. 2 and 3.

FIG. 5 provides a front view of an exemplary case associated with the competitor or participant fish culling and weighing and reporting system of FIGS. 2-4.

FIGS. 6-8 provide a series of exemplary screen shots associated with a mobile application running on a mobile device in connection with the competitor or participant fish culling and weighing and reporting system of FIGS. 2 and 3.

FIGS. 9-14 provide a series of exemplary screen shots associated with a application running on a computer in connection with the Fishing Competition Management and Administration Central server system of FIG. 1.

### DETAILED DESCRIPTION

The present inventions will now be described in more detail with reference to exemplary embodiments as shown in the accompanying drawings. While each aspect of the present invention is described herein with reference to the exemplary embodiments, it will be understood the present invention is not limited to such exemplary embodiments. Those possessing ordinary skill in the art and having access to the teachings herein will recognize additional implementations, modifications, and embodiments, as well as other applications for use of the invention, which are fully contemplated herein as within the scope of the present invention as disclosed and claimed herein, and with respect to which the present invention could be of significant utility.

The present invention provides an enhanced and improved FCMA system for managing events, such as fishing tournaments, registering competitors and maintaining competitor profiles, interacting with a variety of databases containing resources and tools useful in conducting FCMA related events and functions. The invention provides an improved way to collect and communicate fishing competition related data to provide real-time event tracking and to make data collection easier, less time-consuming, more accurate, and more uniform throughout competitors participating in fishing tournaments and other events.

The present invention provides a weighing scale capable of communicating through IoT technology to a plurality of receiving devices. The weighing scale has the ability to communicate to “cull devices” which will flash an LED to represent a desired cull activity. A set of cull devices may have different colors of LEDs to help distinguish one from the others. The weighing scale records the weight of each fish caught and communicates through Internet or other wireless connectivity to a smart phone and to a central (FCMA) database system. The weighing scale communicates to other electronic devices, fish finders, mobile devices, or other integrated technologies. The weighing scale weighs, and when so configured the application, stores, and identifies which cull device contains the certain weight of a fish and will alert the fishing angler which fish in a live well needs to be culled and returned to the water. The weighing scale contains either an analog or digital display, e.g., a touchscreen LED screen, which illuminates various data elements to the angler. A remote database system records culling activity from each user, either independently, in a group (tournament) or other desired formats and reports various key information to interested parties. Parties would include (competing anglers, tournament director(s), fish and wildlife, family, friends, or the anglers themselves. The weighing scale and/or the application records GPS information of each catch and records to the remote database system for further analytics and data services to offer to users or other 3rd parties. A mobile application downloaded and running on a smart phone integrates with the culling system, central server and remote database. A Web application integrates with the culling system, a central server and a remote database. The weighing scale is waterproof and is battery operated with a rechargeable function. The cull mechanisms are waterproof and are rechargeable battery operated. The “CullMaster” system captures culling data for various uses and provides “Leaderboard” functionality application available for users, competitors, family, friends, or other interested third parties. One or more cull devices (Primary cull) may include a water (live well) temperature sensor and communicates live well temperature to a connected smart device and other devices. The Primary cull or other cull may include a ph meter to determine alkalinity of live well water oxygen content of the water and fish health.

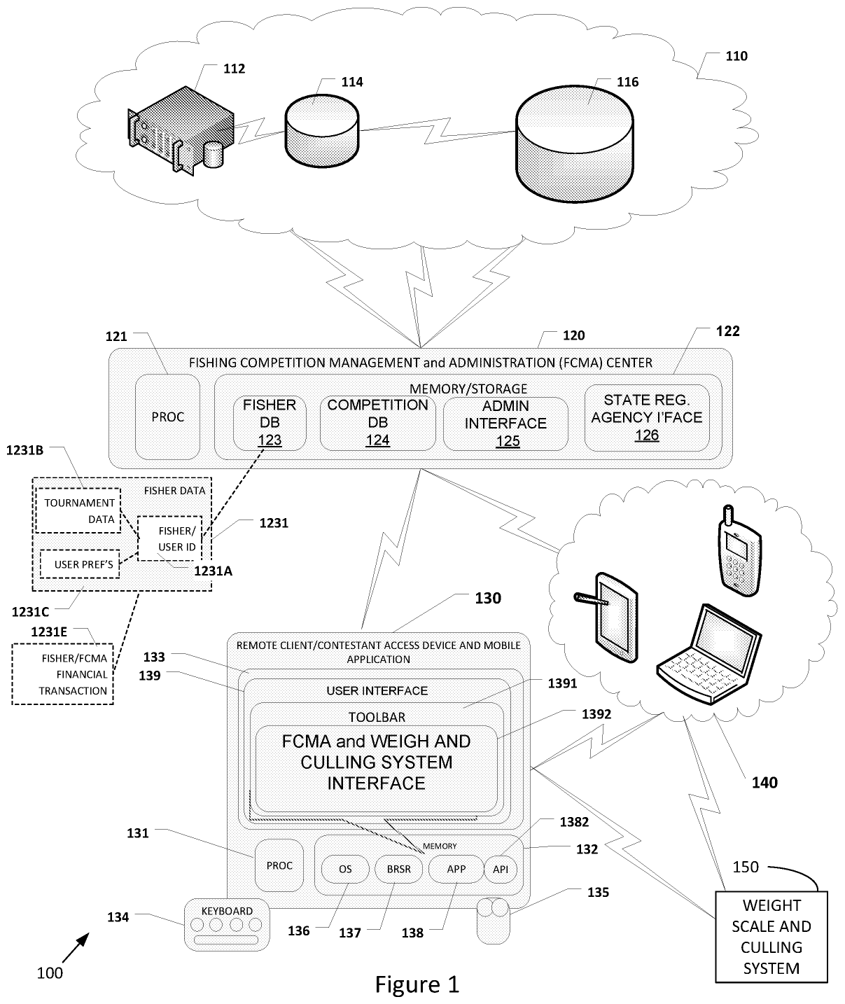

Now with references to the figures. With reference to FIG. 1, an exemplary embodiment of a cloud-based wireless communications-enabled fishing competition (or tournament) management and administration (“FCMA”) system 100 for use in connection with the present invention is adapted to integrate with either or both of a central cloud-based service provider 110 and/or a FCMA central or local (onsite) server 120 (such as a tournament administrator running a fishing competition onsite) in connection with a plurality of remote client-operated devices 130 (such as fishing competitors competing onsite at a tournament). The FCMA center may operate locally on one or more local devices, e.g., devices including computers, PDAs, smart phones, tablets or other smart devices generally represented at 140. FCMA System 100 may be connected to one or more databases 110, e.g., operated by a central service provider for assisting in the operation and maintenance of the FCMA system 100, which may comprise one or more servers 120 in communication with one or more access devices 130, and one or more local devices 140. For example, fishing competitors may use remote devices 130 to sign up for tournaments and to communicate with tournament officials operating the tournament, e.g., via devices 140 running center 120. FCMA administrators or officials may register participants and sign-in registered participants in advance of a tournament held at a fishing site, e.g., a lake or river or ocean. Using the components of the invention as described below, the tournament administrators and the competitors may upload/download, track and monitor tournament results in essentially real-time.

In one implementation, the present invention is provided as a web-based or cloud-based software-as-a-service (SaaS) system 100 wherein the system may be accessed via a network by the local FCMA access devices 140 and fisher or angler (used interchangeably herein) competitor mobile devices 130. As illustrated in FIG. 1, the FCMA system 100 includes FCMA central server 120/140, FCMA administrator interface 125, remote competitor devices 130, and a user interface 139 operating on remote access devices 130. The user interface 139 may be a web browser such as Microsoft Internet Explorer®, an independent application running on the remote access device 130, or a mobile “app” running on one of the remote access devices 130. In this embodiment, the present invention provides for the registration and creation of fishing competitor profiles stored in a user or registry database, which may be a subscriber or angler database 123 co-located with the FCMA server 120 or may be a separate organization-maintained database. The FCMA system 100 may include an interface with an agency-maintained database (e.g., state department of wildlife maintaining fishing license records) accessible via a communications network, e.g., database 114 housed in a license database and/or as stored in a separate third-party provided database 116 with access via an interface 122 operating on the FCMA server 120. The registry databases 114 and 116 may be stored on or accessed by a database server 112.

Database 110 may comprise a combination of internal, external, and/or third-party databases. For example, multiple states or fishing organizations participating in the FCMA-based service may share or exchange angler profile, licensing, tournament, and other information to allow for a broader cross jurisdiction FCMA system. The database server 112 may also include additional databases relating to subscriber information, mapping information, and other systems to provide enhanced services. The other databases may be accessible for use by system 100 to manage and track fishing tournament records.

Databases 110, which take the exemplary form of one or more electronic, magnetic, or optical data-storage devices, include or are otherwise associated with respective indices (not shown). Each of the indices includes terms and phrases in association with corresponding document addresses, identifiers, and other conventional information. Databases 110 are coupled or couplable via a wireless or wireline communications network, such as a local-, wide-, private-, or virtual-private network, to server 120.

Server 120, which is generally representative of one or more servers for providing FCMA functionality through one or more service modules to administrators, participants and observers. More particularly, server 120 includes a processor module 121, a memory module 122, a fisher database 123, a competition database 124, an FCMA administrator interface 125, and a state registry or agency interface 126. Processor module 121 includes one or more local or distributed processors, controllers, or virtual machines. Memory module 122, which takes the exemplary form of one or more non-transitory electronic, magnetic, or optical data-storage devices, stores a fisher database 123, which may be loaded from an external database such as database 116, a competition database 124, an FCMA interface 125, and state registry or agency interface 126. The FCMA admin interface 125 comprises a set of commands and functions for managing fishing tournament services by the FCMA system. The State registry or agency interface module 126 comprises a set of commands and functions that facilitate interaction of FCMA system 100 with state and other authority systems operated by state, local or other jurisdictions (e.g., states or cities or counties) which may be stored locally in the server 120 or may be loaded from the database server 112. The Fisher Database 122 may comprise registry capabilities to directly enroll anglers into the FCMA system and may comprise a set of commands and functions that implement registry and management functionality although this may be handled via separate agency functions, e.g., DOT.

Fisher database 123 may include fisher-related data for controlling, administering, and managing membership or subscription-based access of databases 110 and tournament information. In the exemplary embodiment, fisher database 123a includes one or more user preference (or more generally user) data structures. In the exemplary embodiment, one or more aspects of the user data structure relate to user customization of various communication and interface options stored as user stored data 1231. User data 1231 also includes user ID 1231A, subscription data 1231B, user preferences 1231C, and external user stored data 1231E. FCMA server 120/140 may include one or more search engines and related user-interface components, for receiving and processing user queries against one or more of databases 110.

Still with reference to FIG. 1, remote angler access device 130 is generally representative of one or more access devices operated by anglers participating in a fishing tournament operated by the FCMA system. In the exemplary embodiment, access device 130 takes the form of a personal computer, workstation, personal digital assistant, mobile smart phone, or any other smart device capable of providing an effective user interface with a server or database. Specifically, access device 130 includes a processor module 131, a memory 132, a display 133, a keyboard or touch screen 134, and a graphical pointer or selector 135. In the exemplary embodiment, processor module 131 takes any convenient or desirable form and includes one or more processors, processing circuits, or controllers. Coupled to processor module 131 is memory 132. Memory 132 stores code (machine-readable or executable instructions) for an operating system 136, a browser 137, and scheduling and management software 138. In one exemplary embodiment, operating system 136 takes the form of a version of the Apple iOS, Android, or Microsoft Windows operating system. Operating system 136 and browser 137 not only receive inputs from keyboard or user input touch pad 134 and selector 135, but also support rendering of graphical user interfaces on display 133. In some embodiments, display 133 may be a touch-screen display and may also serve to receive user inputs. Upon executing FCMA client-side application 138 by processor 131, a FCMA interface 1392 integrated into the graphical-user interface 139 of the application software 138 is defined in memory 132 and rendered or presented on display 133. Upon rendering, interface 139 presents data in association with one or more interactive control features (or user-interface elements) which is stored in memory as API 1382. The FCMA interface 1392 may also be loaded into the user interface 139 of the browser 137.

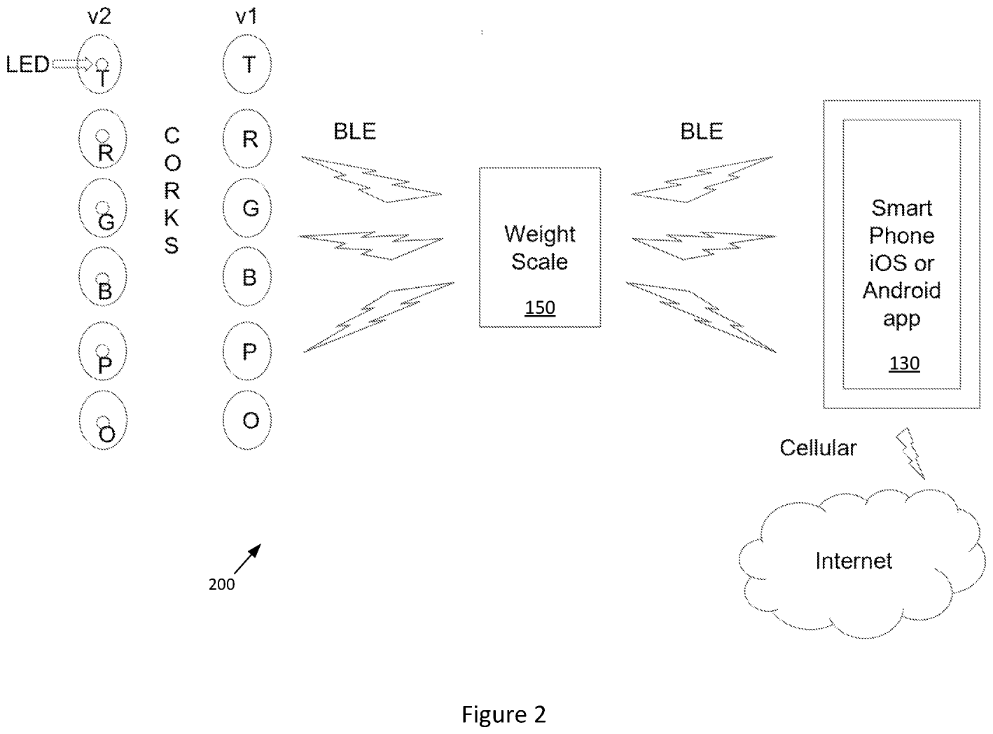

With reference now to FIG. 2, an exemplary embodiment of a competitor or participant fish culling and weighing and reporting system 200 is shown for use in connection with the FCMA system 100 in accordance with the present invention. As shown, the system 200 includes a weight scale 150 device configured to provide Bluetooth BLE communications interface (or other suitable protocol) with a set of culls or corks 202 and a smart phone or other smart device 130 operated by a competitor in a fishing event. The weight scale is used to weigh fish caught during a competition. Each caught fish is weighed, measured and the data collected is stored on the weigh scale 150.

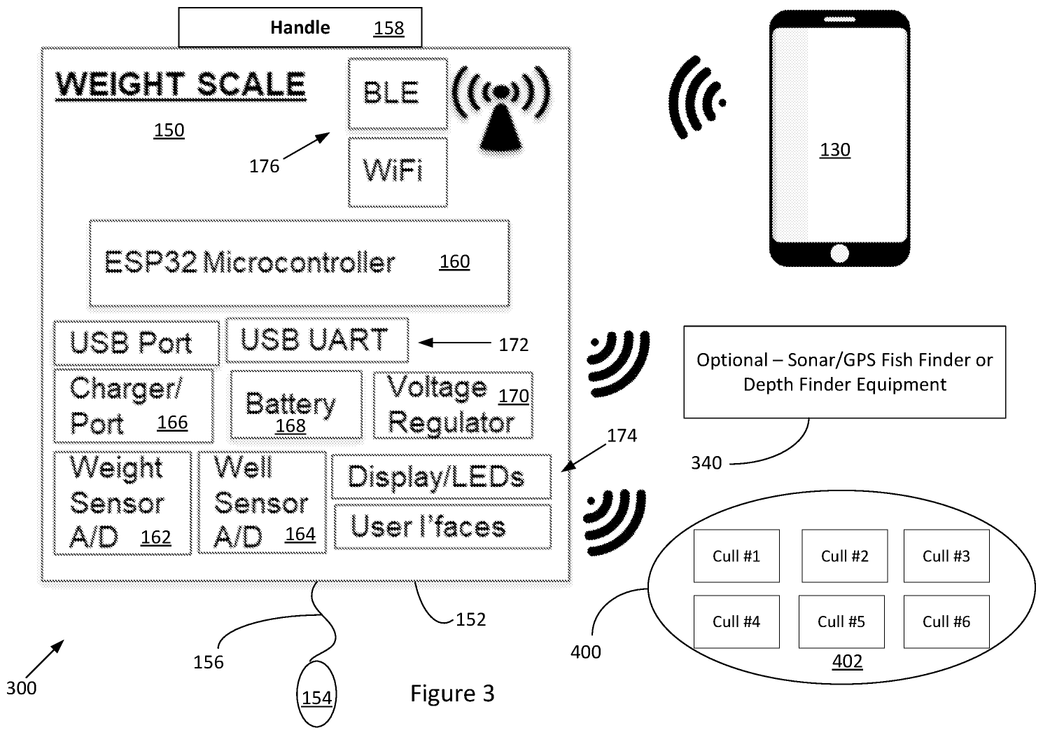

FIG. 3 provides a more detailed functional block diagram of the exemplary competitor or participant fish culling and weighing and reporting system 300. The system 300 components include interoperable communications capabilities. For example, Bluetooth BLE (Bluetooth low energy) will be used as the communication protocol. Other protocols such as UWB, Wi-Fi and/or other Radio Frequency devices may be incorporated into the design.

Here a more detailed depiction shows weight scale 150 having a housing or body 152, a handle 158, a lead or line 156 and a fish weighing attachment 154. Weight scale 150 includes within housing 152 a microcontroller 160 (e.g., an ESP32-based microcontroller), a weight sensor or load cell 162 (such as in the form of an analog-to-digital converter), a well sensor 164 (such as in the form of an analog-to-digital converter), a charger/port component 166, a battery 168, a voltage regulator 170, a USB port and USB UART 172, a set of user interface and display devices 174.

The Weigh or Culling Scale 150 is a device used to weigh fish, receive user inputs and display information via a screen and/or LEDs or other devices. Here the microcontroller 160 is an ESP32-based Bluetooth/BLE supported device, such as Wi-Fi modules made by Espressif Systems (model ESP32-WROOM-32D) and available from Digi-Key Electronics. ESP32 is a system on a chip (SoC) that integrates the following features: Wi-Fi, Bluetooth, dual Xtensa 32-bit LX6 CPU processor cores, ultra-low power co-processor, and peripherals. Espressif provides hardware and software resources to help application developers implement solutions using the ESP32 firmware. Espressif provides a software development framework (including API (software libraries and source code) and Toolchain scripts to compile code) directed to development of Internet-of-Things (IoT) applications with Wi-Fi, Bluetooth, power management and other system features. The USB integration provided with the ESP32 may be either USB A or micro-USB B or USB C type connectors and the SoC operates in connection with computers running Windows, Linux and macOS operating systems. The Weigh or Culling Scale 150 includes additional components such as USB Full Speed to Serial UART IC, Includes Oscillator and EEPROM, SSOP-28—Part No: FT232RL available at FTDIChip.com

Battery 168, e.g., 3.7V rechargeable lithium-ion (Lipo) battery available from YDLBattery including Model DTP603443, may be housed in an accessible battery compartment (not shown) and may be chargeable (e.g., via charger port 166) and/or disposable and replaceable. The V_Batt provided by the battery may be conditioned and regulated, e.g., voltage regulator 170, to provide a regulated voltage as a source to electronic components. A display screen may be in the form of a color touchscreen and additional lights and indicators may be used for user notification. The load cell or sensor is capable of handling accurate weighing of fish intended to fall within an anticipated range during competition, e.g., weights up to 25 pounds. HX711 Amplifier for load sensor. The fish attachment 154 may be a small, but heavy duty clamp adapted for attaching to a fishes mouth and supporting the weight of a fish being weighed, i.e., would need to support 25 pounds, or 11.34 kg. The lead or line 156 may be a type of plastic coated strong leader (Ball/bead chain, cable chain, etc.) to attach culling float to clamp and may be approximately ten inches in length.

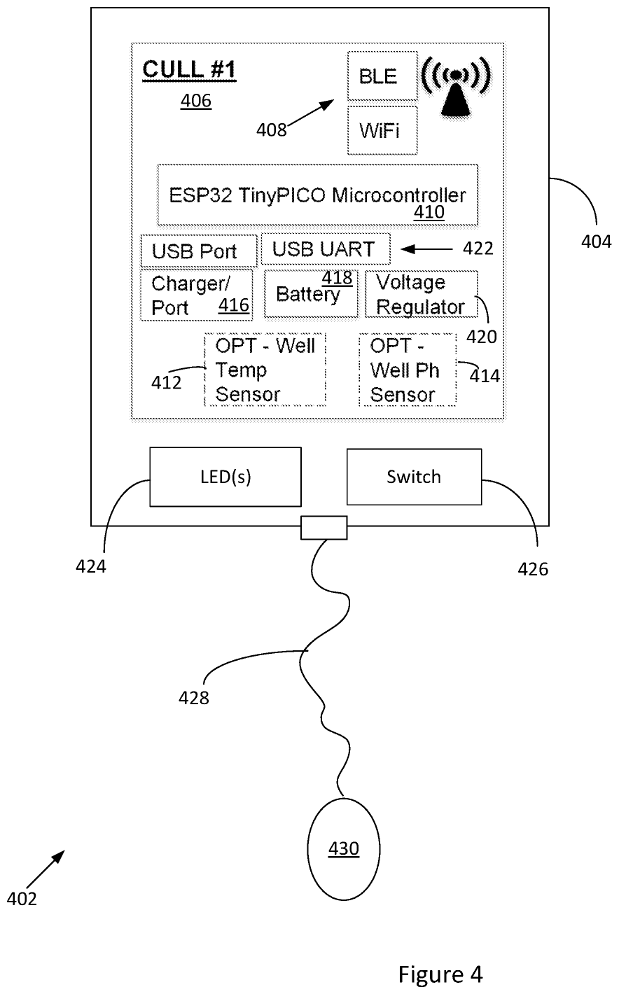

The weigh scale 150 is configured to communicate via BLE with the set of cull floats or devices 400, which includes six separate cull float devices 402. Each cull float device is adapted to attach to a fish and is waterproof and adapted for disposing in a live well environment during a tournament. The cull float 402 is described in more detail in connection with FIG. 4.

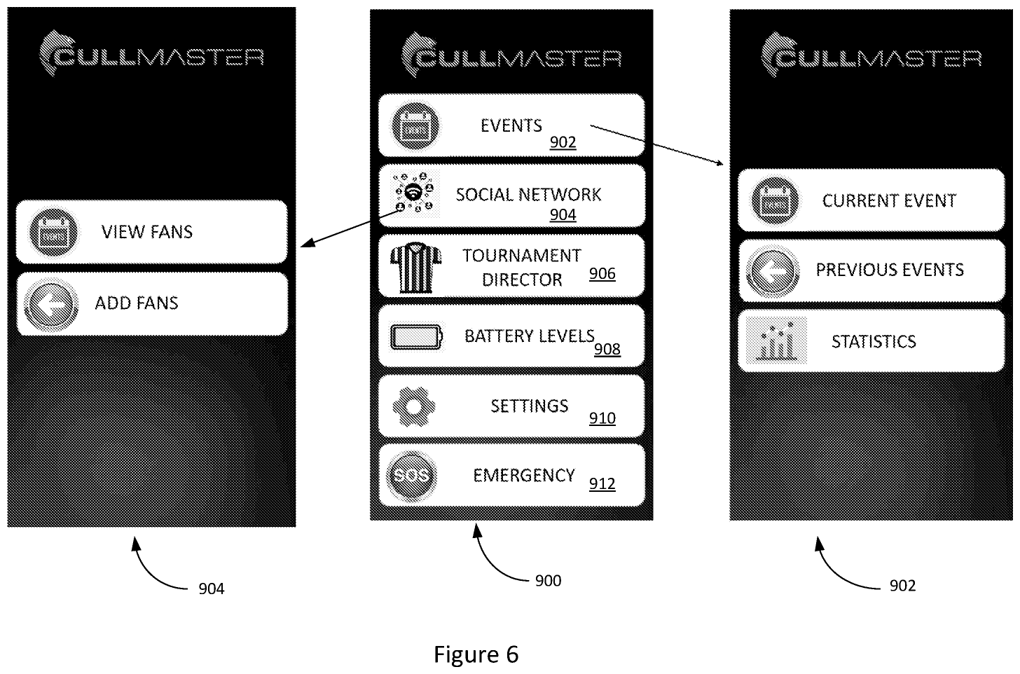

The weigh scale 150 is configured to communicate via BLE or Wi-Fi protocol with a smart phone or other compatible smart device used by an angler during the tournament. The smart phone may communicate directly with the cull devices 400/402. The weigh scale 150 may be in direct communication with the FCMA center administrator 120/140 (FIG. 1) and may communicate tournament information to the center over a connected network. In this manner, real-time data collected by the set of competing anglers may be collected and communicated to the tournament administrator and via FCMA center 120/140 and/or 110, may provide ongoing updates to the anglers as to order of placement based on collected results at any given time up through completion or termination of the tournament. The smart phone/device 130 operating an associated FCMA app (see FIGS. 6-8) may communicate directly with the FCMA center administrator 120/140 (FIG. 1) or with a separate server 110 (FIG. 1) and display tournament data via the app.

In addition, the system 300 may include an optional external screen add-on, or would work to integrate or communicate with on-boat electronics and/or fish finders (e.g., devices made by Lowrance, Humminbird, and/or Garmin) to provide an on-boat display device—represented by reference number 340.

FIG. 4 provides a detailed functional block diagram of an exemplary cull device 402 associated with the competitor or participant fish culling and weighing and reporting system of FIGS. 2 and 3. Here, cull float device 402 includes a waterproof body or housing 404, a power switch 426, and a lead or line 428 connected to a fish attachment 430. The fish attachment 430 adapted to be fixable onto a fish and removable for detachment and release from the fish, e.g., at end of tournament or when culling the fish from the storage well. In addition, and within housing 404, the cull float device includes a microcontroller 410, a charger/port component 416, a battery 418, a voltage regulator 420, a USB port and USB UART 422.

In addition and optionally, at least one cull device from the set of cull devices may have an optional live well temperature sensor 412 to monitor the temperature in the live well to insure it is within an acceptable range to store caught and tagged fish for the duration of the tournament. The temperature for the particular body of water at which a tournament is being held may be measured on or about the date of the competition and entered either manually or centrally into the competition data and automatically set in the FCMA and weight scale system. A predetermined range or tolerance may be set to allow acceptable temperature variation within the live well from an ideal water temperature, e.g., the temperature of the body of water being fished.

Also, the fish weighing and culling system may provide at least one cull device with an optional live well potential hydrogen (“ph”) (acidic-basic) sensor 414 to monitor and insure the live well provides a healthy ph environment for the fish collected and placed in the well. The ph-scale is 0-14 with 7 being neutral (pure water), less than 7 acidic, and more than 7 basic. In connection with tournaments at any given body of water, the system may be adjusted to set a threshold or trigger range of ph that sets off a warning for the live well condition. For instance, sea water is generally a ph of 8, freshwater lakes, ponds and streams typically have a pH of 6-8 depending on the surrounding soil and bedrock, deeper lakes have stratification (layering) and the pH of water is generally higher (7.5-8.5) near the surface and lower (6.5-7.5) at greater depths. The ph for the particular body of water at which a tournament is being held may be measured on or about the date of the competition and entered either manually or centrally into the competition data and automatically set in the FCMA and weight scale system. A predetermined range or tolerance may be set to allow acceptable ph variation from the ideal ph, e.g., the ph level of the body of water being fished.

The Culling Float 402 is a device used to tag and identify fish collected and placed in a live well. Indicators, such as LEDs 424 provide easy identification of fish tagged and placed in the live well. Here the microcontroller 410 is an ESP32-based Bluetooth/BLE supported device, such as TinyPICO model made by Seon Rozenblum (Unexpected Maker) (or alternatively WROOM ESP32 contained in the Weigh Scale). Battery 418, e.g., 3.7V rechargeable lithium-ion (Lipo) battery available from YDLBattery including Model DTP603443, may be housed in an accessible, waterproof battery compartment (not shown) and may be rechargeable (e.g., via charger port 416) and/or disposable and replaceable. The V_Batt provided by the battery may be conditioned and regulated, e.g., voltage regulator 420, to provide a regulated voltage as a source to electronic components.

The LED(s) 424 are adapted to flash when an associated cull float is triggered. In the exemplary set of six culls, a different color (or may be different color light and/or LED) is assigned to each cull float. In this example the light/LED colors are T-Tan; R-Red; G-Green; B-Blue; P-Purple; W-White; and O-Orange. The fish attachment or clamp 430 may be a small, but heavy-duty clamp adapted for attaching to a fish's mouth and supporting the weight of a fish being weighed, i.e., would need to support 25 pounds, or 11.34 kg. The lead or line 156 may be a type of plastic-coated strong leader (Ball/bead chain, cable chain, etc.) to attach culling float to clamp and may be approximately ten inches in length.

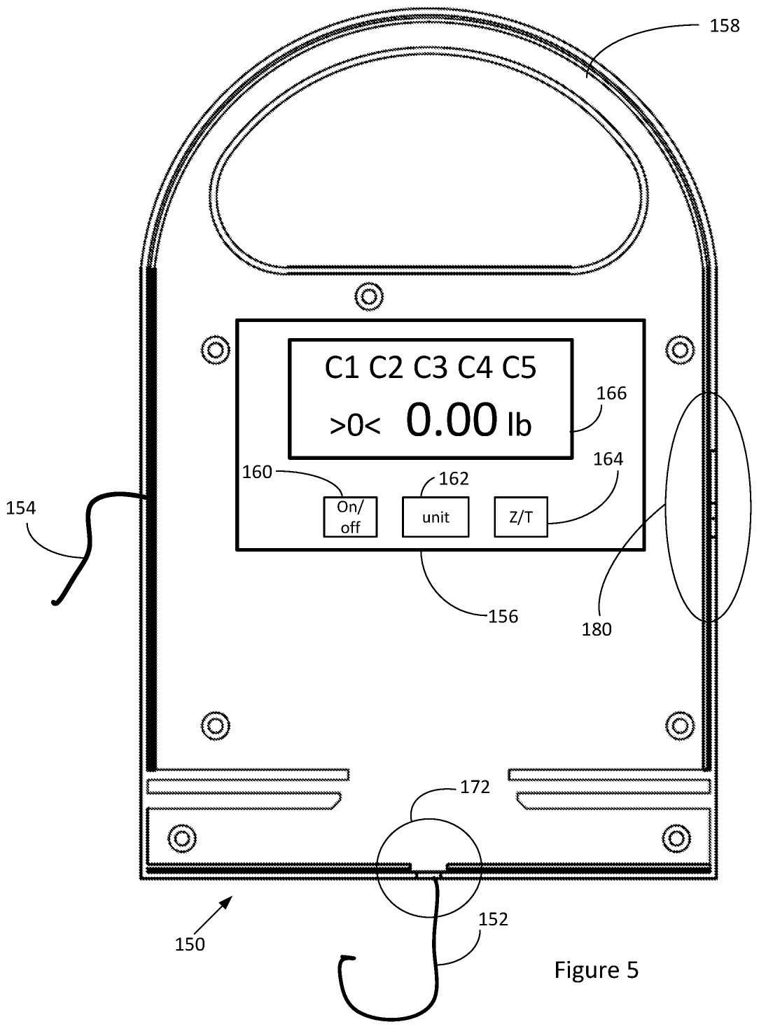

FIG. 5 provides a front view of an exemplary case 150 associated with the competitor or participant fish culling and weighing and reporting system of FIGS. 2-4. Here weigh scale 150 includes a case having a housing or body and a handle 158, a hood-shaped or “J”-shaped fish attachment 152 operatively connected to a weight measuring component for weighing fish, a length measuring device 154, e.g., a measuring tape which may be retractable into a cavity formed in the case, a man machine interface device 156, which may include a display 166, an on/off button 160, a unit selection button or toggle 162, a fish or cull information input button or toggle 164, and a display 166, e.g., for displaying the weight of a fish attached to attachment 152. Display 166 may be capable of displaying information in different colors. For example, the set of culls C1-C5 may be shown and may be color matched to the cull devices used to identify fishes contained in a live well. The handle 158 may be used during weighing a fish and collecting measured data and the data may be selectable by a switch or other user interface for displaying information of interest to the user. A clasp 180 secures the housing in a closed position while allowing the device to be opened. The set of cull floats may be stored in the housing when not in use. Also, one or more ports and/or connections 172 are included on the scale and may include a rechargeable port or connection, a USB or other data connection port may be provided along with additional interconnections with equipment stored in the housing so that the complete weigh scale and cull float system may be charged simultaneously and from a single source. The scale 150 may include a door or cover to conceal and protect features or access points, e.g., replace a battery. In one example the weight scale device includes a highly accurate weighing feature for accurately weighing fish. The scale 150 includes a sensor made of thick aluminum alloy for accurate and consistent measurement. The display 166 of the fish scale shows weight in severable units, e.g., lb/kg/oz, selectable by unit button 162 and weighs fish or other items weighing up to 110 lbs or 50 kgs. The scale may include a metal force-bearing structure with thick outer shell including a handle portion 158. Optionally the scale 150 may be shaped to provide a pistol grip Hook 152 is made of, e.g., 4 mm high strength stainless steel capable of supporting fish or other items weighing up to 110 lbs or 50 kgs and is operatively coupled to a weight sensor component. The weight sensor fish attachment may be in a form other than a hook, e.g., a clamp, and may include adaptors or other intermediate pieces to facilitate weighing fish. Also, the culls C1-C5 may include a quick attachment feature to facilitate attaching the fish and a quick attachment feature to facilitate attaching the fish and cull to the hook or other weigh connection feature connected to the weigh sensor. The scale 150 includes a built-in tape measure 154 for measuring length of a fish or other object. The scale includes electronics and display, e.g., LCD, requiring power and includes a battery or manual crank component to generate power. The scale 150 is a “hanging” type scale and may include a rubber coated handle configured for a comfortable and secure grasp of a fisherman when in use to measure fish fresh out of water. The hook 152 is large enough for sport fishes and for other objects such as luggage handles. A strap may be provided for securing other objects to the hook. The display screen 166 of the fish weighing scale 150 provides relatively large well illuminated LCD digits for easy reading including in bright sunlight and may include a sun shield to block sunlight. The scale includes “Z/T” button 164 for setting or resetting the scale between zero and tare settings. For example with the scale resets to zero for next fish weighing. The Tare function is selected to weigh items inside a container or with a known attachment such as a cull C1-C5 while avoiding the need for math calculations. The fish weighing scale 150 may also include overload and low battery indication, auto-off function, timed display shutdown, weight reset and other features to aid the fisherman or other user. One such feature is a data hold function that enables a fisherman to read after putting down the object being weighed.

Initially, a user, such as a competing angler registered with an FCMA center to participate in a fishing event, downloads a mobile FCMA app to a smart phone or smart device. Alternatively, the user could navigate through an Internet-based interface if no mobile app is available. Although a tournament director or administrator associated with the FCMA system is likely to access a central server or the like to perform operations associated with creating and running a fishing event, the tournament director may also utilize a mobile app version of the FCMA system to perform operations. Fans, spectators and other non-competing event enthusiasts may also access event information by way of a mobile app running on a smart device.

FIGS. 6-8 provide a series of exemplary screen shots associated with a mobile application running on a mobile device in connection with the fish culling and weighing and reporting system of FIGS. 2 and 3.

The mobile app should be both Android and IOS, and will serve multiple purposes. There may be three modes for logging into the app: 1) Tournament Director, 2) Competing Angler, and 3) Spectators. Each mode may present a different experience tailored to the type of user identified and may permit access based on user type. A user profile is set up based on user data input into the FCMA system and passwords and other login and authorization assigned by an administrator. Initially, the user at first time installation downloads the app from an app store associated with the user mobile device (Apple Store or Android-based app store). Next the user connects to FCMA “Culling System” to pair with the user's mobile device. Once credentials are set and the app loaded onto the smart device, the user may operate the functions provided by the app for that user type.

For the “Tournament Director” type user, the user logs in using the assigned credentials, and may set about performing functions allowed for the user type. For example, the TD-type user may set up a new tournament with the following data: Tournament Name, Tournament Date, Tournament location, Particular Fishing League, Number of competing anglers, Start time, Finish time, Number of fish limit for tournament (usually 1, 3, or 5), Prizes Awarded, and Name of the body of water. The TD-type user may, after creating a new event and saving the event profile on the FCMA system, later edit the event information prior to or during the event.

For the “Competing Angler” type user, the user logs in using the assigned credentials, and may set about performing functions allowed for the user type. For example, the CA-type user may “Select Mode” for the fishing day (All anglers or Single Angler, combined weight of the boat or individual anglers). The CA-type user may sign on or login to a selected Tournament Name established by Tournament Director to register for the tournament. The FCMA system may have an existing profile associated with the user and/or user team and may recall the profile in connection with the registration process. This could be used as Single Mode only. The user may establish a new profile with the user and/or user team or may simply enter all registration information from a blank form provided via the FCMA mobile app. Information input by the user, directly or via existing profile, includes for example: Give Team Name; Input boat number drawn for that tournament; Sync culls to Culling System to ensure pairing; Hit “Ready” button to put angler in competition mode; Go catch some fish and start weighing. The FCMA app running on a user smart device enables the user to view scoreboard of total weight of each competitor or Single Angler. In addition, the user may view battery level of culling devices and weigh scale. The user may select “Finished Fishing” button, which will cause the app to perform the following steps: Provide total weight; Slow flash culling float of biggest fish in the live well (this is helpful because most tournaments reward the for the biggest fish with prize money, and sometimes the angler is guessing which one is biggest when fish are close in size; and perform any necessary system shutdowns to save battery life.

For the “Spectator” type user, the user logs in using the assigned credentials, and may set about performing functions allowed for the user type. For example, the SP-type user may: Select tournament they wish to follow or view; See complete scoreboard of every boat and their total weight; and Select competing angler from list, and drill down on every fish caught and culled.

The FCMA may also allow one or more of the user types to view historical records to show results of prior fishing events. For example, the FCMA mobile app may permit the user to do one or more of the following: review results of any past tournament the user participated in (or those the user did not participate in); view or perform or access analytics of catch history, finishing place in tournament, and other related data; create graphs of certain elements; allow angler to input other relative data for each catch, e.g., water temperature, lure used, depth fished, retrieve speed; and when GPS coordinates are collected, show map of lake and place virtual pins or markers where fish were caught.

As shown in FIG. 6, this exemplary version of the FCMA mobile app presents a logged in user with an initial or home screen 900 having a set of “buttons” selectable by the user to navigate to portions or segments of the mobile app. In this case the mobile app home page 900 includes the following user sections or pages or segments: Events 902; Social Network 904; Tournament Director 906; Battery Levels 908; Settings 910; and Emergency 912. This may be an example of a TD-type user having functions associated with a tournament director available at the TD page 906. If the user logs in as a competing angler CA-type user then in place of a TD page 906 the app may present a CA page related to items of interest to a competing angler, rather than a tournament director. Likewise, if the user logs in as a SP-type user then the page 906 may be tailored and limited to Spectator items of interest and information.

As shown, upon selecting “Events 902” page the mobile app presents screen 902 and the user is directed to a page showing sub-buttons or features including: Current Event, Previous Events, and Statistics. The user may select Current Event and the mobile app will present the user with information concerning a current event. For example, the app may provide the user with date of event, event check in time, begin and end times, requirements of the event, rules of the event, competitors registered for the event, etc. If the user selects Previous Events, then the user may be presented with information related to past events include leaderboards, order of finish, event statistics, dates of events, etc. If the user selects the Statistics button, the user may be presented with a set of fishing event related statistics. The statistics may be related to individual events, a set of events that span a time period, e.g., a given year or season, a set of individual or team statistics, or a set of league related statistics. The app may be configured to allow the user to perform certain statistical operations or manipulations such as supported by a central server serving the app and related functions.

Upon selecting “Social Network 904” page, the mobile app presents screen 904 and the user may be presented with a set of sub-buttons or features such as “View Fans” and “Add Fans.” The mobile app may also allow a user to connect with FCMA related social media accounts or postings and/or individual/team angler social media postings or accounts at one or more social media sites, e.g., Facebook, Instagram, Snapchat, TikTok, etc.

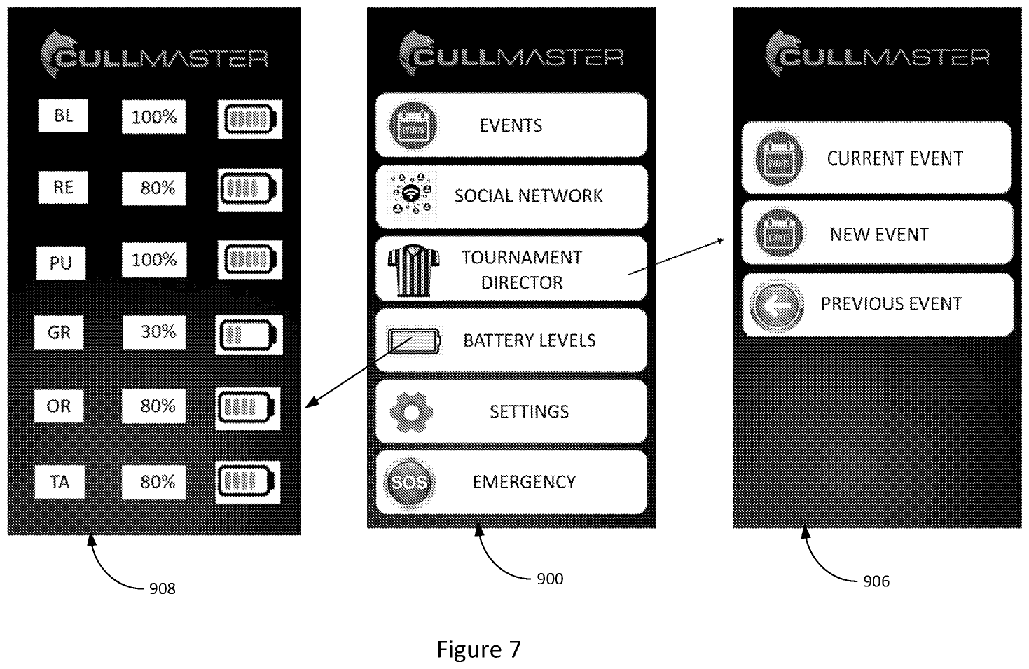

As shown at FIG. 7, upon selecting the TD button 906, the mobile app presents screen 906 and the user is directed to a page having a set of sub-buttons or features related to tournament director items of interest or functions including: Current Event; New Event; and Previous Event. At Current Event, the TD-type user is authorized to edit previously created events that are current and open prior to or during competition or event occurrence. The user may be permitted to alter criteria of the event, e.g., the number of participants, other rules of the event, date or time of the event (e.g., if weather causes a cancelation or change in date), change participant information, etc. As discussed above, upon selecting “New Event” button or feature the mobile app may allow the user to create a new event. The user may be able to pre-populate event criteria based on prior events or a template. Also, the user may view historical records and previous event data by selecting “previous Events” button.

Upon selecting the Battery Levels button 908, the mobile app presents screen 908 and the user is directed to a page having a set of battery levels corresponding to the weight scale and the set of cull float devices 1-6 using the color codes assigned to each cull device. The user can monitor that battery level and confirm all equipment is properly charged prior to and during a competition.

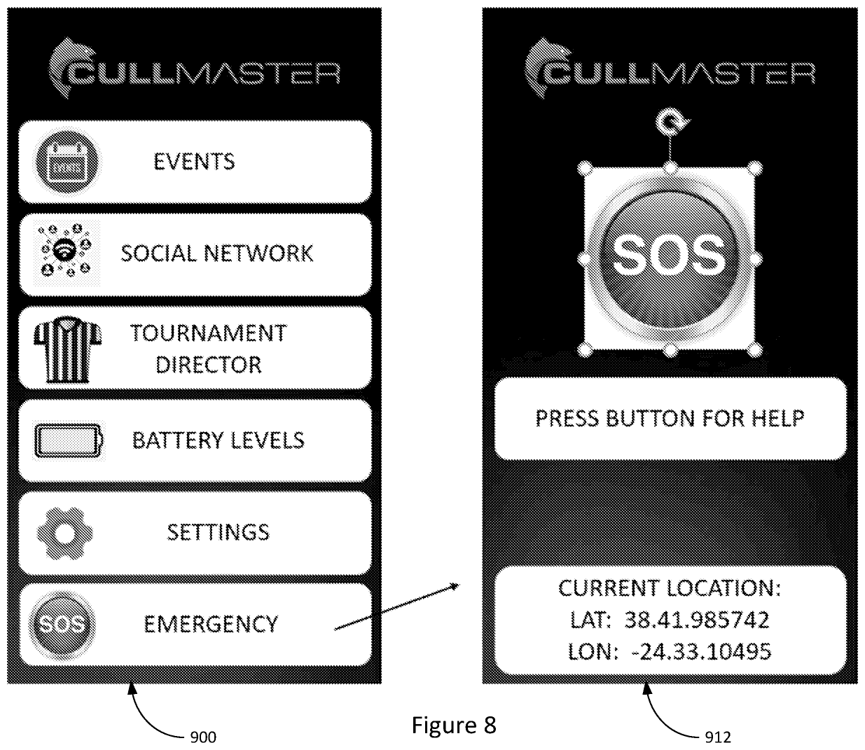

As shown at FIG. 8, upon selecting the “Emergency” button 912, the user is presented with a screen 912 that includes an “SOS” call for help button. The mobile app creates an emergency help signal and forwards location information, such as provided via GPS and indicating latitude and longitude of the user (e.g., location on the lake where the user with the smart phone is situated during a tournament or otherwise).

Although no separate screen is shown for representing the page for “Settings” 910, such a page may include a variety of user profile settings, device settings, including for the weigh scale and cull float devices used in competition.

In addition, the mobile app may include a button to enable a user to connect to a commercial website associated with an entity providing and selling the weigh scale and cull float devices and other competition products. For example, the user may be able to order and purchase new products and may be allowed to download updates to software running on the weigh scale and cull float device products. The site may include marketing, product and possibly video footage for sales and tutorial purposes. The website may include a mirror of the information collected using the weigh scale and cull float devices via the smart phone and historical data. It may be possible to view the same data on the website as the mobile app.

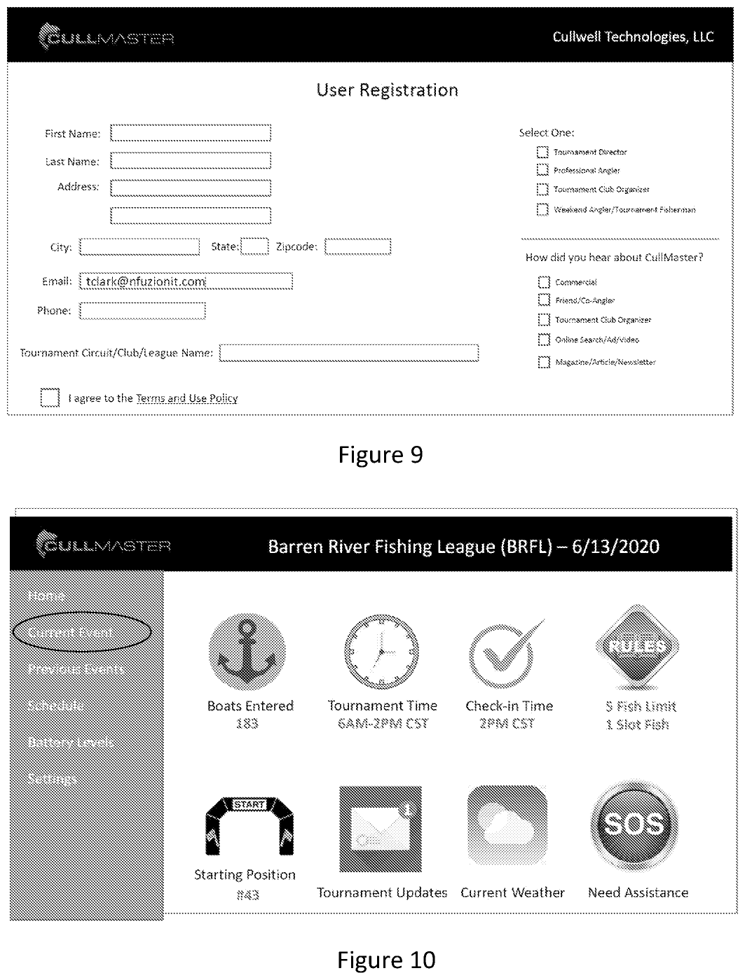

FIGS. 9-14 provide a series of exemplary screen shots associated with an application running on a computer in connection with the Fishing Competition Management and Administration Central server system of FIG. 1.

FIG. 9 illustrates a user registration screen and online form for receiving user inputs. Based on the information submitted by the user, a user profile is created and stored within the FCMA database—for instance as an angler competitor. Two or more users may register and form a team profile or other form of linking the profiles via traditional relational database methods and data structures. FIG. 10 illustrates a “Current Event” web page for an event titled “Barren River Fishing League (BRFL)” and includes information concerning and about the event. Here the number of “Boats Entered” is 183, the tournament time is 6 AM-2 PM CST, the check-in time is 2 pm CST, the “Rules” include a five fish limit and one slot fish, the user's starting position for this event is listed as “#43” and there are links to other information such as tournament updates, current weather and Assistance needed.

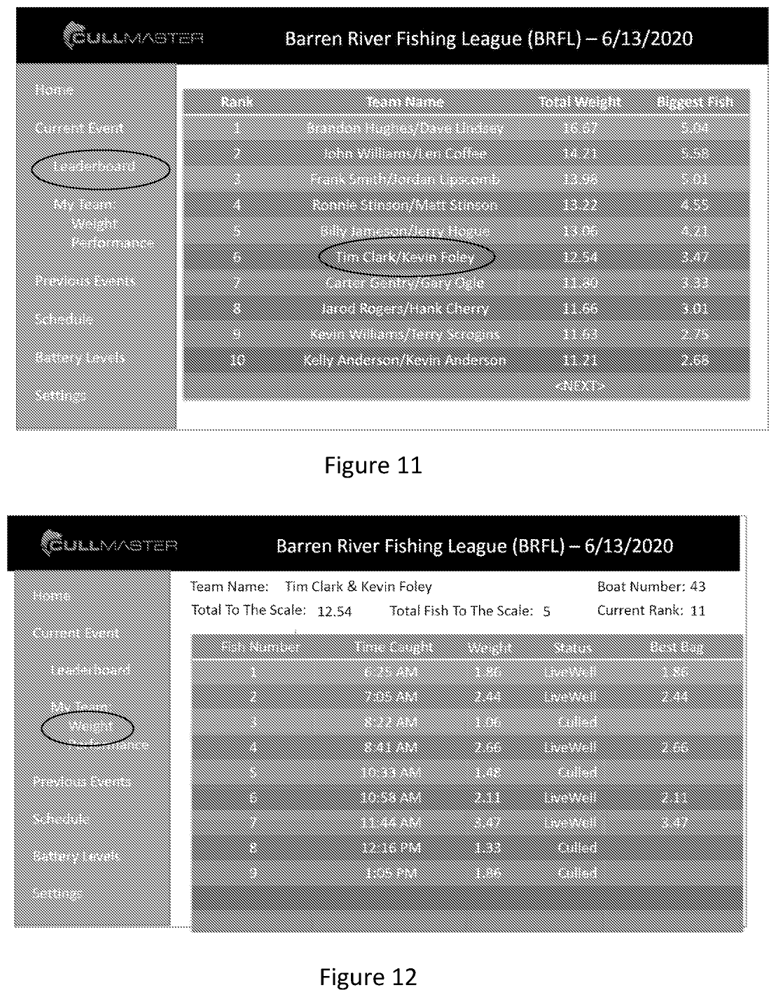

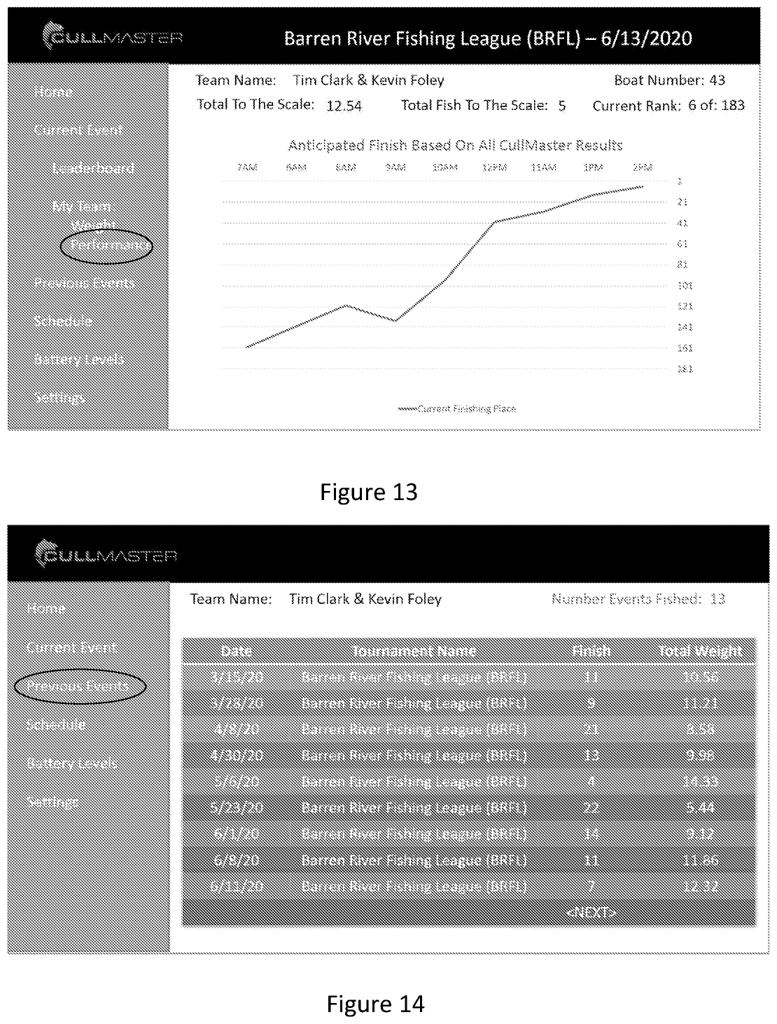

FIG. 11 illustrates a “Leaderboard” associated with the BRFL league organized by “Rank” and identifying the team names, the total weight of record, and the biggest fish caught by the teams. In this instance the team names include active links that allow the user to obtain more information about a team of interest. Here, upon selecting Ranked team #6 “Tim Clark/Kevin Foley” from the “Team Name” list or, if the user is Clark or Foley, by selecting the “My Team” page on the left-hand side of the user interface, the user is presented with the “My Team” “Weight” screen of FIG. 12. The Team view page of FIG. 12 includes a listing of the fish caught by the Clark/Foley team during the tournament and shows of the nine fish caught, four were culled and five were retained in the live well for the competition. The team page shows the team's current rank “11”, boat number “43”, fish scaled/weighed “5”, and the total weight to scale “12.54” with the “best bag” being “3.47.” Upon selecting the “Performance” page under “My Team”, the user is presented with the Performance screen or page of FIG. 13.

The Performance screen of FIG. 13 presents a graph showing an estimated or anticipated finish ranking of the team based on all team results over the duration of the event—here from 7 AM to 2 PM. Here the Clark/Foley Team has a current rank of “6 of 183” in the competition with a total fish to scale of 5 and a total weight to scale of “12.54.” Upon selecting the “Previous Events” tab or page the user is directed to the page of FIG. 14 showing a set of (9 out of 13) previous events associated with the BRFL league in which the Clark/Foley team competed between Mar. 15, 2020 and Jun. 11, 2020.

Additional pages or tabs associated with the user interface are “Schedule”, “Battery Levels”, and Settings.” Schedule may include items such as upcoming fishing events or other scheduled events. The Battery Levels page may show the battery levels of the personal or team weight scale and culling devices used by the team and sensed and communicated to the FCMA via one or more wireless connections. Settings may include weight scale and cull float device settings, user profile and preferences settings, and other items of interest to the user.

While the inventions of the inventive aspects have been described by reference to certain preferred embodiments, it should be understood that numerous changes could be made within the spirit and scope of the inventive concept described. Also, the present invention is not to be limited in scope by the specific embodiments described herein. It is fully contemplated that other various embodiments of and modifications to the present invention, in addition to those described herein, will become apparent to those of ordinary skill in the art from the foregoing description and accompanying drawings. Thus, such other embodiments and modifications are intended to fall within the scope of the following appended claims. Further, although the present invention has been described herein in the context of particular embodiments and implementations and applications and in particular environments, those of ordinary skill in the art will appreciate that its usefulness is not limited thereto and that the present invention can be beneficially applied in any number of ways and environments for any number of purposes. Accordingly, the claims set forth below should be construed in view of the full breadth and spirit of the present invention as disclosed herein.

What is claimed is:

1. A fish weighing and data collection system comprising:
a transportable fish weighing device adapted to be field deployable for remote use on watercraft, the fish weighing device comprising:
a weighing component configured to measure the weight of a fish;
a processor configured to execute instructions;
a memory configured to store data and instructions executable by the processor; and
a first communication component configured to wirelessly communicate with a cull device set and to wirelessly communicate with a mobile device;
the cull device set comprising one or more cull devices, each cull device from the cull device set comprising:
an attachment component configured to attach the cull device onto a fish in a fixed but removable manner for intended detachment from the fish;
an indicator adapted to distinguish the cull device from an other cull device from the cull device set; and
a second communication component configured to wirelessly communicate with the fish weighing device;
wherein the fish weighing device measures and stores in the memory the weight of each fish attached to respective cull devices from the cull device set; and
wherein the first communication component is adapted to establish a wireless connection with a mobile device and generate a signal to transmit weight information representing the measured weight of each fish attached to respective cull devices stored in the memory.

2. The fish weighing and data collection system of claim 1 wherein the first and second communications components are configured to communicate using IoT technology.

3. The fish weighing and data collection system of claim 1, wherein the fish weighing device comprises a load cell or weight sensor configured as an analog-to-digital converter, and wherein the fish weighing device measures and stores in the memory the weight of each fish caught and communicates stored information through one or more of Internet, Wi-Fi, Bluetooth, BLE, IoT, NFC, RF or other wireless connectivity to one or more communicatively connected devices.

4. The fish weighing and data collection system of claim 3 wherein the communicatively connected devices include one or more of computer, smart phone, connectable wearable device, fish finder, mobile computing device, or other integrated technologies.

5. The fish weighing and data collection system of claim 1 wherein the fish weighing device processor is configured to execute instructions stored in the memory and compare, based on the stored fish weight information, relative weights of fish associated with respective cull devices and to generate a signal representing an identification of a fish in a live well to be culled in place of a newly weighed fish.

6. The fish weighing and data collection system of claim 1 further comprising a visual display adapted to present to a user information related to the system.

7. The fish weighing and data collection system of claim 1 wherein the first communication component is adapted to transmit collected and stored fish weight information to a database.

8. The fish weighing and data collection system of claim 7 wherein information is communicated to a mobile device operating an application adapted to receive data from the fish weighing device and is communicated to the database via the mobile device.

9. The fish weighing and data collection system of claim 7 wherein the database collects information and generates records associated with a plurality of users, and wherein the collected information includes culling activity from each user.

10. The fish weighing and data collection system of claim 7 wherein the database is configured to publish collected information via a remotely accessible hosted service, and wherein access to the hosted service is account-based.

11. The fish weighing and data collection system of claim 10 wherein the database is operated on a computer configured to provide a “Leaderboard” functionality application available to interested parties.

12. The fish weighing and data collection system of claim 1 wherein the fish weighing device records GPS information associated with a location of each fish caught and associated with a cull device.

13. The fish weighing and data collection system of claim 1 further comprising a mobile application configured to be operated via the mobile device, to receive data from the fish weighing device, and to communicate with a remote database.

14. The fish weighing and data collection system of claim 1 wherein the fish weighing device and the cull device set are configured to be waterproof and comprise a rechargeable battery.

15. The fish weighing and data collection system of claim 1 further comprising a water temperature sensor adapted to be disposed in a live well with one or more fish each having an associated cull device attached thereto and emit a signal representing a sensed water temperature, and wherein the fish weighing device or the mobile device is adapted to receive the signal from the water temperature sensor.

16. The fish weighing and data collection system of claim 1 further comprising a ph sensor adapted to be disposed in a live well containing fish with attached cull devices, wherein the fish weighing device is adapted to receive a signal from the ph sensor and to determine an alkalinity level of the live well water.

17. A method for collecting and storing fish weight data, the method comprising:
measuring, by a transportable fish weighing device, the weight of a fish, and generating a signal representing measured fish weight data;
storing, by a memory in the transportable fish weighing device, the measured fish weight data;
wirelessly communicating, via a first communication component of the transportable fish weighing device, with a cull device set;
attaching the cull device onto a fish in a fixed but removable manner for intended detachment from the fish;
wirelessly transmitting a signal, via a second communication component of the cull device, to the fish weighing device, the signal comprising a set of data representing measured fish weight data; and
wirelessly connecting with a mobile device and generating a signal to transmit weight information comprising the weight of each fish attached to respective cull devices stored in the memory.

18. The method of claim 17, further comprising:
comparing, by a processor configured to execute instructions stored in the memory of the fish weighing device, based on the stored fish weight information, relative weights of fish associated with respective cull devices; and
generating a signal representing an identification of a fish in a live well to be culled in place of a newly weighed fish.

19. The method of claim 17, further comprising:
capturing and storing GPS information associated with a location of each fish caught and associated with a cull device.

20. The method of claim 17 further comprising transmitting a signal representing measured fish data from the fish weighing device to a mobile device via an application running on the mobile device.
